(19) United States
(12) Patent Application Publication
(10) Pub. No.: US 2017/0046740 A1
(43) Pub. Date: Feb. 16, 2017

(54) METHODS AND SYSTEMS RELATING TO CLICK-THROUGH ADVERTISING

(71) Applicant: MOHAMAD ABBAS, OTTAWA (CA)

(72) Inventor: MOHAMAD ABBAS, OTTAWA (CA)

(21) Appl. No.: 14/825,321

(22) Filed: Aug. 13, 2015

(51) Int. Cl. G06Q 30/02; G06Q 50/00; H04L 29/08

(52) U.S. Cl. CPC G06Q 30/0257; H04L 67/02; G06Q 50/01

(57) ABSTRACT

Advertisers today seeking to exploit social networks and social media to garner one of the oldest and most effective advertisements, word of mouth and the recommendation of a friend, colleague, family member, etc. At the same time “friction” for users has become more important over time in that users want to get to the desired information or perform a desired action with the minimum effort, i.e. mouse clicks, webpages, etc. It would be beneficial for an advertiser to establish a presence with a user with low friction and further beneficial for that low friction engagement to then result in the advertiser or the advertiser's content being pushed from a user to other users to establish their presence with these other users and reduce the friction between the advertiser and these other users

### FIELD OF THE INVENTION

This invention relates to advertising and more particularly to click-through advertising embedded with features upon an electronic device displayed to the user of the electronic device or transmitted to another user based upon the feature selected.

### BACKGROUND OF THE INVENTION

Advertising using traditional media, such as television, radio, newspapers and magazines, is well known and despite the penetration of digital media over the last decade is still the basis of the majority of advertising for most customers. Traditional media has maintained its position as whilst advertising over more interactive media using digital media has become popular the early explosion of Internet advertising led to the concept of “spamming” which is the use of electronic messaging systems to send unsolicited bulk messages, especially advertising, indiscriminately. As such e-mail systems and e-mail service providers now include filters to remove these. Similarly, Internet browsers can be configured by user to eliminate “pop-up” webpages which are a similar source of frustration to users. However, advertisers have come to appreciate both the benefits and drawbacks of traditional media as well as the digital media and services that can be offered over the Internet. Advertisers have with time developed a variety of strategies in an attempt to maximize the value of their advertising and its return on investment. Once such strategy has advertisers using popular presences or means for providing interactive media or services, which are referred to as “websites” within this specification which may for example comprise one or more linked pages of content, as channels to reach a large audience.

Within advertising on the Internet when a user is interested in an advertisement presented to them they select the advertisement by clicking on it such embedded hypertext links typically direct the user to the advertiser's website. This process, is commonly referred to as a “click-through” and the ratio of the number of click-throughs to the number of impressions of the advertisement (i.e., the number of times an advertisement was displayed or otherwise rendered) is commonly referred to as the “click-through rate” or “CTR” of the advertisement. It is common for advertisers to be charged based upon factors such as click-through or CTR in addition to, in many instances, a basic fee.

Historically, advertiser's sought a “conversion” which occurs when a user consummates a transaction related to a previously served advertisement. What constitutes a conversion may vary according to the advertiser such that in one instance a conversion is the sequence when a user clicks on an advertisement, is linked to a webpage or website specified by the advertiser and makes a purchase there before leaving the webpage/website. In other instances a conversion may be defined by an advertiser to be any measurable/observable user action such as, for example, downloading predetermined content, navigating to a predetermined point/depth within a website, viewing at least a certain number of webpages, or the user spending a predetermined amount of time on the webpage/website is commonly referred to as the conversion rate.

However, today advertisers are also seeking to exploit social networks and social media to garner one of the oldest and most effective advertisements, word of mouth and the recommendation of a friend, colleague, family member, etc. At the same time the issue of “friction” for users has become more important over time with the proliferation of content, websites, social networks, social media etc. in that the user seeks to get to the desired information or perform a desired action with the minimum effort, i.e. mouse clicks, webpages, etc.

Accordingly, it would be beneficial for an advertiser to establish a presence with a user with low friction. It would also be beneficial for that low friction engagement to then result in the advertiser or the advertiser's content being pushed from a user to other users to establish their presence with these other users and reduce the friction between the advertiser and these other users

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to advertising and more particularly to click-through advertising embedded with features upon an electronic device displayed to the user of the electronic device or transmitted to another user based upon the feature selected.

In accordance with an embodiment of the invention there is provided a method of

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts examples of portable electronic devices and wearable technology supporting embodiments of the invention;

FIG. 2 depicts a network environment within which embodiments of the invention may be employed;

FIG. 3 depicts a wireless portable electronic device supporting communications to a network such as depicted in FIG. 2 and as supporting embodiments of the invention;

FIG. 4 depicts an exemplary sequence of filters provided to a user within an application according to an embodiment of the invention;

FIG. 5 depicts an exemplary sequence of filters provided to a user within an application according to an embodiment of the invention; and

FIG. 6 depicts an exemplary sequence of filters provided to a user and subsequent message to another user within an application according to an embodiment of the invention.

### DETAILED DESCRIPTION

The present invention is directed to advertising and more particularly to click-through advertising embedded with features upon an electronic device displayed to the user of the electronic device or transmitted to another user based upon the feature selected.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

An “application” (commonly referred to as an “app”) as used herein may refer to, but is not limited to, a “software application” and an element of a “software suite” as used herein may refer to, but is not limited to, a computer program designed to allow an individual to perform an activity. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED for the purposes of presenting a micro-survey to a consumer and/or customer.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitterm); content communities (for example, YouTube and DailyMotion); social networking sites (for example, Facebookm); virtual game-worlds (e.g., World of Warcraft™); and virtual social worlds (e.g. Second Lifem).

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A ‘third party’ or “third party provider” as used herein may refer to, but is not limited to, a so-called “arms length” provider of a service and/or a product to an enterprise and/or service provider wherein the consumer and/or customer engages the third party but the actual service and/or product that they are interested in and/or purchase.

A “user” as used herein may refer to, but is not limited to, an enterprise, a service provider, and an individual accessing at least one of publishing software and/or publishing software according to embodiments of the invention from the viewpoint of publishing information.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Biometric” information as used herein may refer to, but is not limited to, data relating to a user with respect to their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, heart rate, temperate, altitude, vibration, motion, perspiration, EEG, ECG, etc. In addition biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

An ‘advertisement” as referred to herein may refer to, but is not limited to, an item of content, a document, advertisement, message, and data at least one of generated, selected, created, modified, and transmitted in response to at least one of a query, search, trigger, alarm, and message.

Reference to “advertisement information” as used herein may refer to, but is not limited to, any combination of advertisement features, advertisement serving constraints, information derivable from advertisement features or advertisement serving constraints (referred to as “advertisement derived information”), and/or information related to the advertisement (referred to as “advertisement related information”), as well as an extension of such information (e.g., information derived from advertisement related information).

Reference to a “document” as used herein may refer to, but is not limited to, any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Advertisement spots in the document may be defined by embedded information or instructions. In the context of the Internet, a common document is a Web page. Web pages often include content and may include embedded information (such as meta information, hyperlinks, etc.) and/or embedded instructions (such as Javascript, etc.). In many cases, a document has a unique, addressable, storage location and can therefore be uniquely identified by this addressable location such as a universal resource locator (URL) for example used as a unique address used to access information on the Internet.

“Document information” as used herein may refer to, but is not limited to, may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

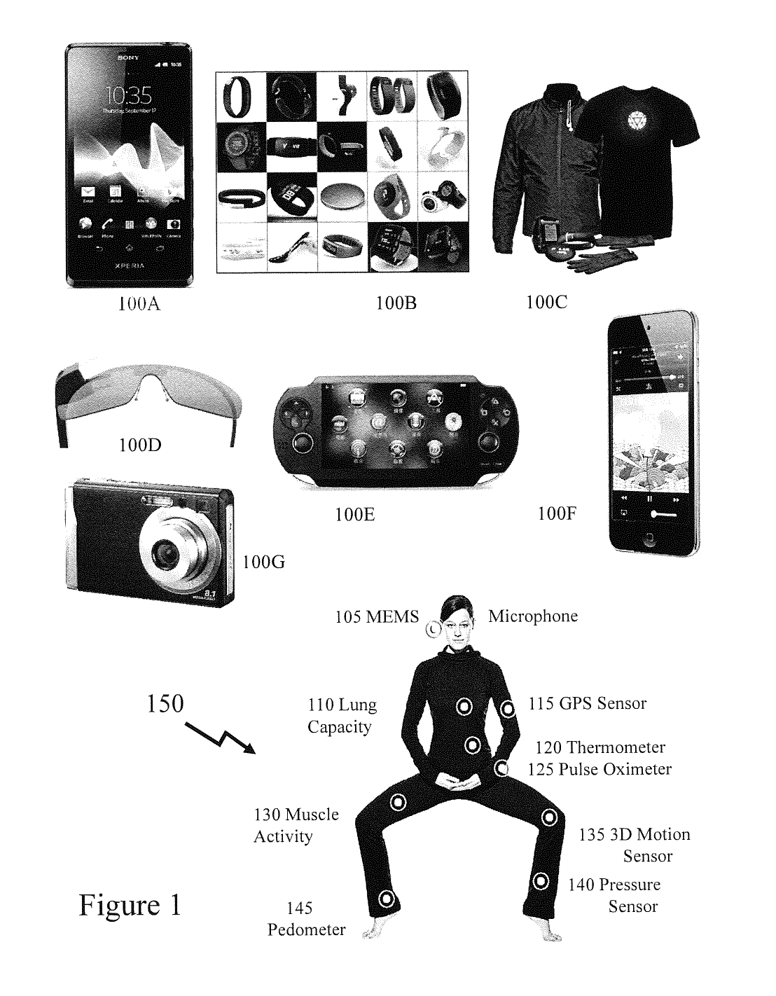

Referring to FIG. 1 there are depicted typical examples of electronic devices associated with users such as smartphone 100A, wearable devices and sensors 100B, smart clothing 100C, head mounted displays 100D, portable gaming console 100E, portable multimedia player 100F, and camera 100G. Portable gaming console 100E, portable multimedia player 100F, and camera 100G representing examples of PEDs employed commonly by user. These may be used by users in isolation, in different combinations, or in combination with other wearable devices as depicted in schematic 150 wherein a user's smart clothing or wearable devices provides data from sensors including, but not limited to, those providing acoustic environment information via MEMS microphone 105, user breathing analysis through lung capacity sensor 110, global positioning via GPS sensor 115, their temperature and/or ambient temperature via thermometer 120, and blood oxygenation through pulse oximeter 125. These are augmented by exertion data acquired by muscle activity sensor 130, motion data via 3D motion sensor 135 (e.g. 3D accelerometer), user weight/carrying data from pressure sensor 140 and walking/running data from pedometer 145.

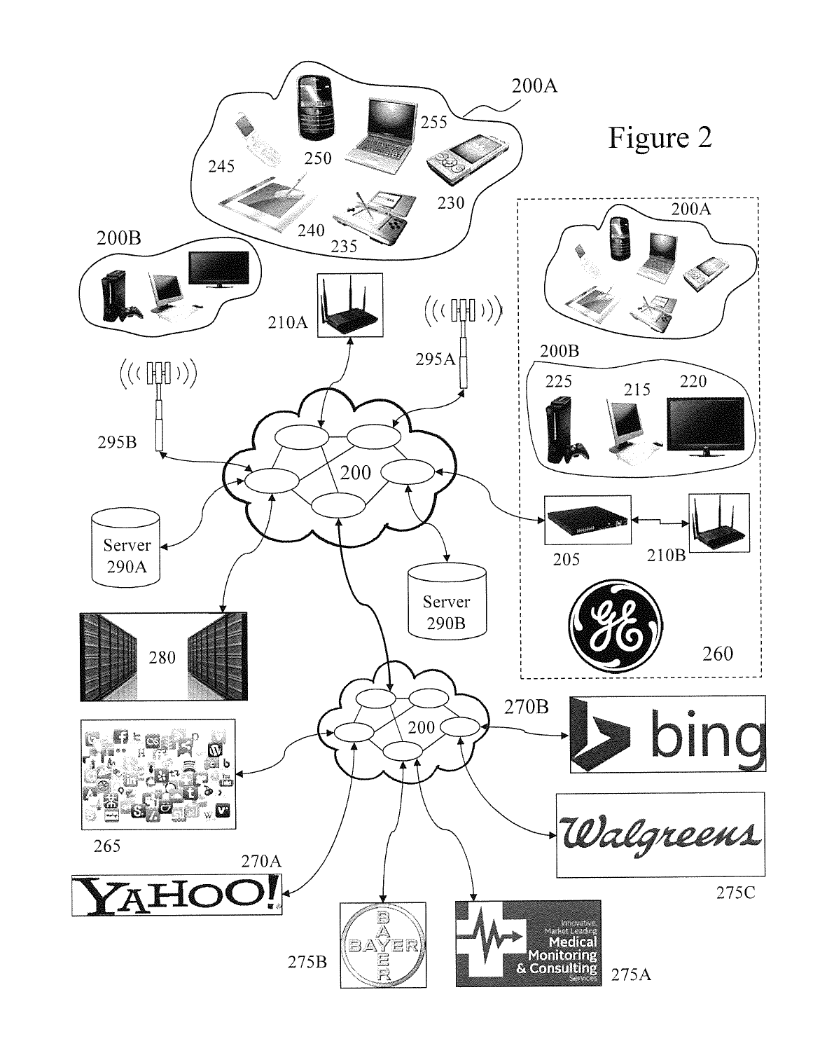

Accordingly, a user within their daily life today has access to multiple PEDs and may perform a wide variety of activities with these including, but not limited to, sending/receiving short message service (SMS) communications such as Tweets, texts, etc.; sending/receiving electronic mail (email); sending/receiving audiovisual communications such as photographs etc. as attachments but also including, for example, Instagram™, SnapChat™, Face Time™, and Skype™; browse the Internet; perform financial transactions; exploiting location based services such as navigation, geotagging, and obtaining geofenced special offers etc. Accordingly, as decribed and depicted below in respect of FIG. 2 through XX the user exploits a range of applications to generate, receive, display and manage information and within these the user accesses a variety of features. Accordingly, embodiments of the invention provide a method for advertisers to present content to the user in association with the features the user selects such that friction is low as the user inherently views the advertisements by selecting features and/or browsing features and then the user's contacts in receiving their content are exposed to the advertising with similarly low friction. Further, as evident from the description below the advertisements can be linked to biometric data, location data, specific features, etc. and combinations thereof.

Referring to FIG. 2 there is depicted a network environment 200 within which embodiments of the invention may be employed supporting advertising systems and publishing applications/platforms (ASPAPs) according to embodiments of the invention. Such ASPAPs, for example supporting multiple channels and dynamic content. As shown first and second user groups 200A and 200B respectively interface to a telecommunications network 200. Within the representative telecommunication architecture a remote central exchange 280 communicates with the remainder of a telecommunication service providers network via the network 200 which may include for example long-haul OC-48/OC-192 backbone elements, an OC-48 wide area network (WAN), a Passive Optical Network, and a Wireless Link. The central exchange 280 is connected via the network 200 to local, regional, and international exchanges (not shown for clarity) and therein through network 200 to first and second cellular APs 295A and 295B respectively which provide Wi-Fi cells for first and second user groups 200A and 200B respectively. Also connected to the network 200 are first and second Wi-Fi nodes 210A and 210B, the latter of which being coupled to network 200 via router 205. Second Wi-Fi node 210B is associated with Enterprise 260, e.g. General Electric™, within which other first and second user groups 200A and 200B are disposed. Second user group 200B may also be connected to the network 200 via wired interfaces including, but not limited to, DSL, Dial-Up, DOCSIS, Ethernet, G.hn, ISDN, MoCA, PON, and Power line communication (PLC) which may or may not be routed through a router such as router 205.

Within the cell associated with first AP 210A the first group of users 200A may employ a variety of PEDs including for example, laptop computer 255, portable gaming console 235, tablet computer 240, smartphone 250, cellular telephone 245 as well as portable multimedia player 230. Within the cell associated with second AP 210B are the second group of users 200B which may employ a variety of FEDs including for example gaming console 225, personal computer 215 and wireless/Internet enabled television 220 as well as cable modem 205. First and second cellular APs 295A and 295B respectively provide, for example, cellular GSM (Global System for Mobile Communications) telephony services as well as 3G and 4G evolved services with enhanced data transport support. Second cellular AP 295B provides coverage in the exemplary embodiment to first and second user groups 200A and 200B. Alternatively the first and second user groups 200A and 200B may be geographically disparate and access the network 200 through multiple APs, not shown for clarity, distributed geographically by the network operator or operators. First cellular AP 295A as show provides coverage to first user group 200A and environment 270, which comprises second user group 200B as well as first user group 200A. Accordingly, the first and second user groups 200A and 200B may according to their particular communications interfaces communicate to the network 200 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 200A may form associations either through standards such as IEEE 802.15 and Bluetooth as well in an ad-hoc manner.

Also connected to the network 200 are Social Networks (SOCNETS) 265, first and second service providers 270A and 270B respectively, e.g. Yahoo™ and Bing™, and first to third party providers 275A to 275C respectively, e.g. Medical Monitoring Service, Bayer™ (a pharmaceutical company), and Walgreen's (a pharmacy company), as well as first and second servers 290A and 290B which together with others, not shown for clarity. First and second servers 290A and 290B may host according to embodiments of the inventions multiple services associated with a provider of advertising systems and publishing applications/platforms (ASPAPs); a provider of a SOCNET or Social Media (SOME) exploiting ASPAP features; a provider of a SOCNET and/or SOME not exploiting ASPAP features; a provider of services to PEDS and/or FEDS; a provider of one or more aspects of wired and/or wireless communications; an Enterprise 260 exploiting ASPAP features; license databases; content databases; image databases; content libraries; customer databases; websites; and software applications for download to or access by FEDs and/or PEDs exploiting and/or hosting ASPAP features. First and second primary content servers 290A and 290B may also host for example other Internet services such as a search engine, financial services, third party applications and other Internet based services.

Accordingly, a consumer and/or customer (CONCUS) may exploit a PED and/or FED within an Enterprise 260, for example, and access one of the first or second primary content servers 290A and 290B respectively to perform an operation such as accessing/downloading an application which provides ASPAP features according to embodiments of the invention; execute an application already installed providing ASPAP features; execute a web based application providing ASPAP features; or access content. Similarly, a CONCUS may undertake such actions or others exploiting embodiments of the invention exploiting a PED or FED within first and second user groups 200A and 200B respectively via one of first and second cellular APs 295A and 295B respectively and first Wi-Fi nodes 210A.

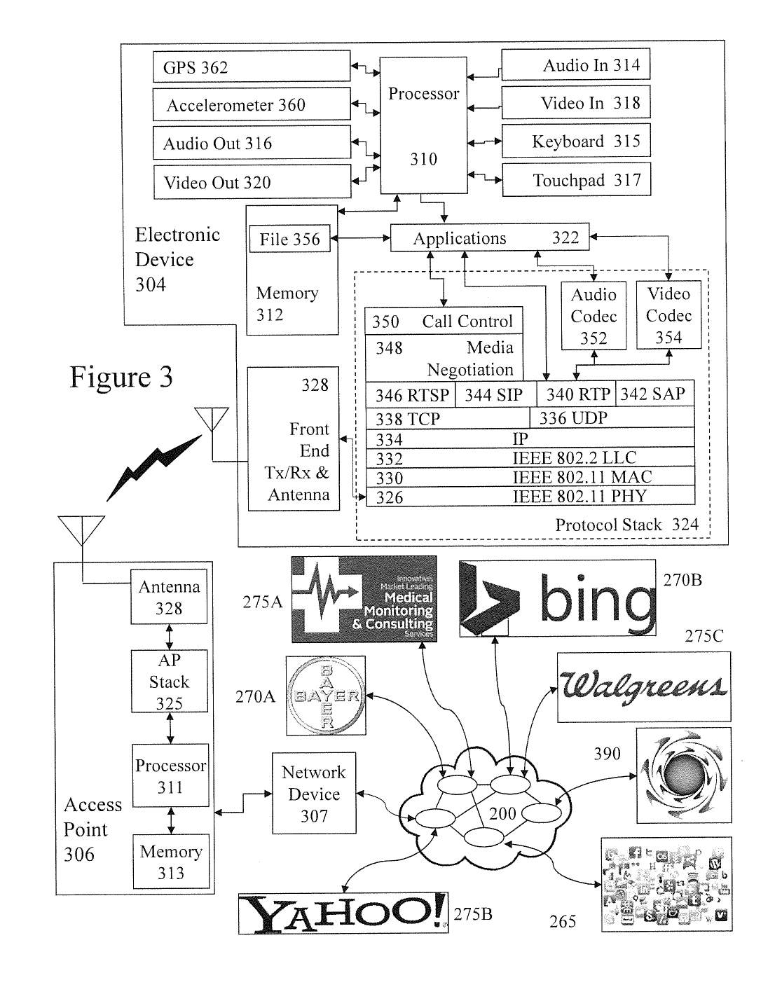

Now referring to FIG. 3 there is depicted an electronic device 304 and network access point 307 supporting ASPAP features according to embodiments of the invention. Electronic device 304 may, for example, be a PED and/or FED and may include additional elements above and beyond those described and depicted. Also depicted within the electronic device 304 is the protocol architecture as part of a simplified functional diagram of a system 300 that includes an electronic device 304, such as a smartphone 255, an access point (AP) 306, such as first AP 210, and one or more network devices 307, such as communication servers, streaming media servers, and routers for example such as first and second servers 290A and 290B respectively. Network devices 307 may be coupled to AP 306 via any combination of networks, wired, wireless and/or optical communication links such as discussed above in respect of FIG. 2 as well as directly as indicated. Network devices 307 are coupled to network 300 and therein Social Networks (SOCNETS) 265, first and second service providers 270A and 270B respectively, first to third party providers 275A to 275C respectively, and biometric database service provider 390.

The electronic device 304 includes one or more processors 310 and a memory 312 coupled to processor(s) 310. AP 306 also includes one or more processors 311 and a memory 313 coupled to processor(s) 310. A non-exhaustive list of examples for any of processors 310 and 311 includes a central processing unit (CPU), a digital signal processor (DSP), a reduced instruction set computer (RISC), a complex instruction set computer (CISC) and the like. Furthermore, any of processors 310 and 311 may be part of application specific integrated circuits (ASICs) or may be a part of application specific standard products (ASSPs). A non-exhaustive list of examples for memories 312 and 313 includes any combination of the following semiconductor devices such as registers, latches, ROM, EEPROM, flash memory devices, nonvolatile random access memory devices (NVRAM), SDRAM, DRAM, double data rate (DDR) memory devices, SRAM, universal serial bus (USB) removable memory, and the like.

Electronic device 304 may include an audio input element 314, for example a microphone, and an audio output element 316, for example, a speaker, coupled to any of processors 310. Electronic device 304 may include a video input element 318, for example, a video camera or camera, and a video output element 320, for example an LCD display, coupled to any of processors 310. Electronic device 304 also includes a keyboard 315 and touchpad 317 which may for example be a physical keyboard and touchpad allowing the user to enter content or select functions within one of more applications 322. Alternatively the keyboard 315 and touchpad 317 may be predetermined regions of a touch sensitive element forming part of the display within the electronic device 304. The one or more applications 322 that are typically stored in memory 312 and are executable by any combination of processors 310. Electronic device 304 also includes accelerometer 360 providing three-dimensional motion input to the process 310 and GPS 362 which provides geographical location information to processor 310.

Electronic device 304 includes a protocol stack 324 and AP 306 includes a communication stack 325. Within system 300 protocol stack 324 is shown as IEEE 802.11 protocol stack but alternatively may exploit other protocol stacks such as an Internet Engineering Task Force (IETF) multimedia protocol stack for example. Likewise AP stack 325 exploits a protocol stack but is not expanded for clarity. Elements of protocol stack 324 and AP stack 325 may be implemented in any combination of software, firmware and/or hardware. Protocol stack 324 includes an IEEE 802.11-compatible PHY module 326 that is coupled to one or more Front-End Tx/Rx & Antenna 328, an IEEE 802.11-compatible MAC module 330 coupled to an IEEE 802.2-compatible LLC module 332. Protocol stack 324 includes a network layer IP module 334, a transport layer User Datagram Protocol (UDP) module 336 and a transport layer Transmission Control Protocol (TCP) module 338.

Protocol stack 324 also includes a session layer Real Time Transport Protocol (RTP) module 340, a Session Announcement Protocol (SAP) module 342, a Session Initiation Protocol (SIP) module 344 and a Real Time Streaming Protocol (RTSP) module 346. Protocol stack 324 includes a presentation layer media negotiation module 348, a call control module 350, one or more audio codecs 352 and one or more video codecs 354. Applications 322 may be able to create maintain and/or terminate communication sessions with any of devices 307 by way of AP 306. Typically, applications 322 may activate any of the SAP, SIP, RTSP, media negotiation and call control modules for that purpose. Typically, information may propagate from the SAP, SIP, RTSP, media negotiation and call control modules to PHY module 326 through TCP module 338, IP module 334, LLC module 332 and MAC module 330.

It would be apparent to one skilled in the art that elements of the electronic device 304 may also be implemented within the AP 306 including but not limited to one or more elements of the protocol stack 324, including for example an IEEE 802.11-compatible PHY module, an IEEE 802.11-compatible MAC module, and an IEEE 802.2-compatible LLC module 332. The AP 306 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 304 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

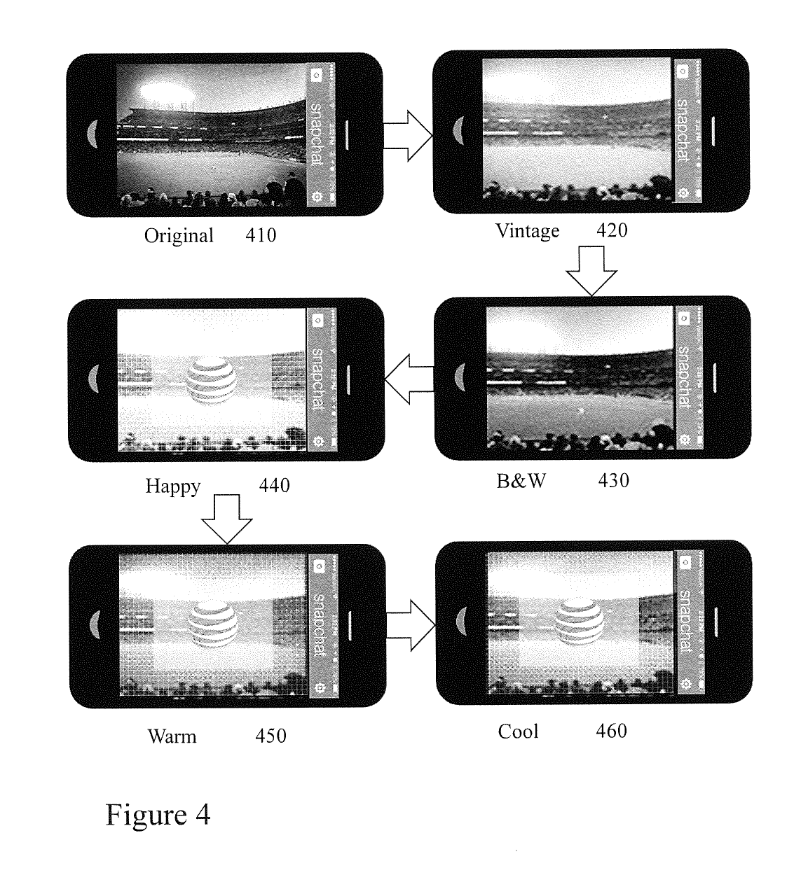

Now referring to FIG. 4 there are depicted a series of images 410 to 460 representing exemplary screen images provided to a user within an application, e.g. SnapChat™, wherein the user in first image 610 has captured an image at an event they are in and has elected to add a filter to the image. Accordingly, through a series of swipe/tap or other gestures/key strokes etc. the user moves through the available filters. Of the available filters the first two presented in second and third images 420 and 430 are absent advertiser content but subsequently the other filters presented in fourth to sixth images 440 to 460 respectively are associated with in application advertising and are associated with different filters. Such filters may be considered “premium” in that the effects they add are more desirable for users (through market research/demographic analysis etc.) or more frequently selected (using analytics of user selections) and others “free.” In each instance the user simply may select the displayed filter and “click-through” the advertisement which results in the transmission of the message to the other selected user or users (e.g. contacts) by the user. Optionally, the user having clicked-through the advertisement may be directed right back to the application or they may be presented with associated advertising of the advertiser associated with the filter they selected.

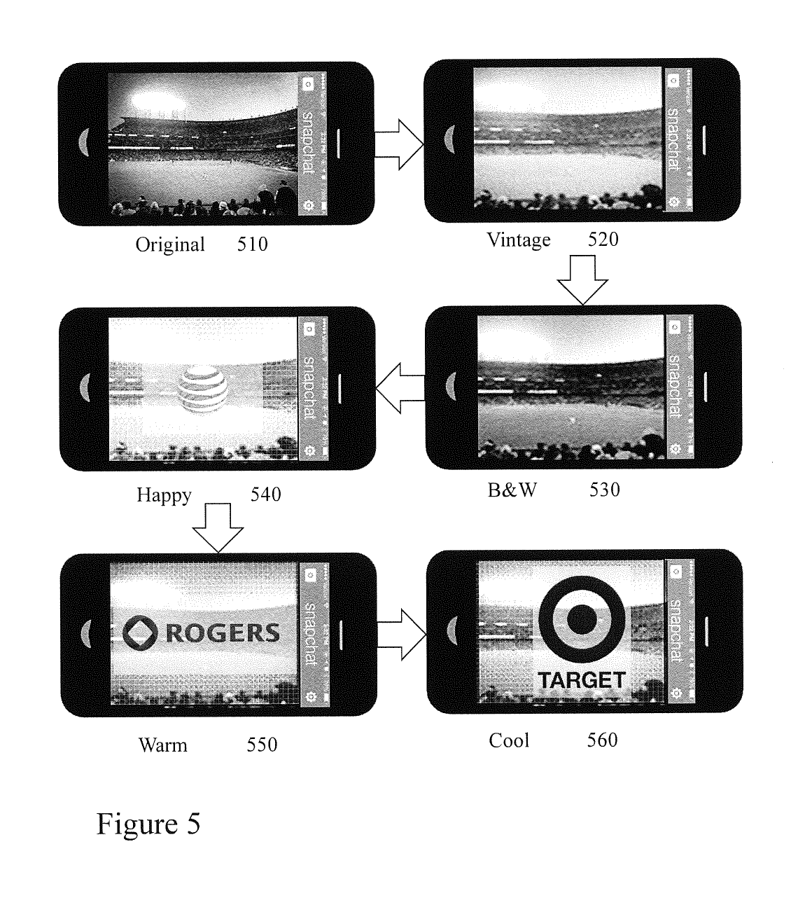

In FIG. 4 the advertiser in all instances is AT&T as the user is within AT&T Park home of the San Francisco Giants baseball team and hence the application based upon the geolocation element of advertiser selection provides this in all instances. However, as evident in FIG. 5 with a series of images 510 to 560 it is evident that the advertiser varies as the user “flips” through the different filters one by one such that third to fifth filters in fourth to sixth images 540 to 560 are now associated with AT&T™, Rogers™, and Target™. The selection of which advertiser to present with which filter may be based upon the application of one or more rules by the ASPAP in execution upon the user's PED and/or remote server based. For example, examples of rules/processes may include:
Displaying advertiser/advertising information associated with a particular geo-location based upon known location sponsorship;
Displaying advertiser/advertising information associated with a particular geo-location based upon known event sponsorship at that location at that time;
Displaying advertiser/advertising information associated with user's recent Internet activity;
Displaying advertiser/advertising information associated with recent keywords in user's electronic messaging;
Displaying advertiser/advertising information associated with one or more factors associated with the user based upon biometric data;
Displaying advertiser/advertising information based upon PED currently employed such that a smartwatch may be presented differently to a smartphone, for example;
Displaying advertiser/advertising information based upon demographic;
Displaying advertiser/advertising information based upon user's historical selections so that an advertiser paying a higher rate is associated with a filter, for example, the user is more likely to use;
Displaying advertiser/advertising information based upon fee paid by advertiser such that higher rates are associated with higher frequency selections by users of the application;
Displaying advertiser/advertising information based upon the content such that for example, an image captured triggers one advertising set whereas a video capture triggers another;
Displaying advertiser/advertising information based upon geolocation/time information;
Displaying advertiser/advertising information based upon identity of the user(s) previously selected by the user to receive the message through remote server access;
Displaying advertiser/advertising information based upon one or more factors associated with the current location of the user(s) previously selected by the user to receive the message through remote server access; and
Displaying advertiser/advertising information based upon one or more factors associated with the current biometrics of the user(s) previously selected by the user to receive the message through remote server access.

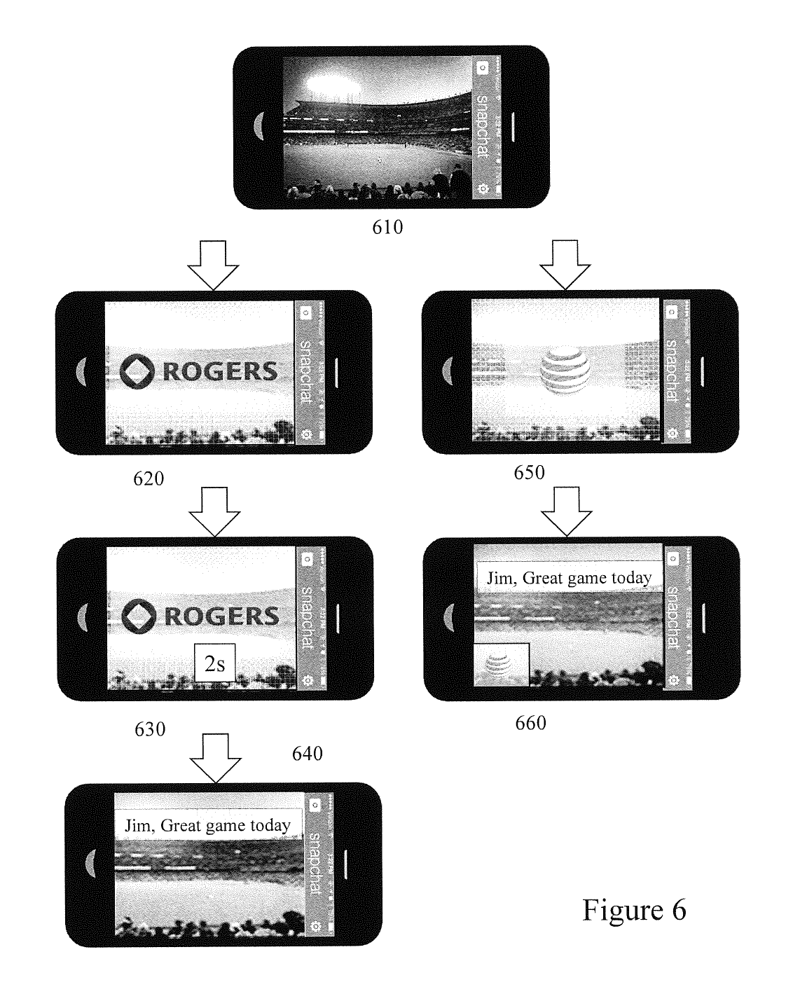

Now referring to FIG. 6 there are depicted a series of images 610 to 660 representing exemplary screen images provided to a user within an application, e.g. SnapChat™, wherein the user in first image 610 has acquired content they wish to transmit and then in second and fifth images 620 and 650 respectively selected different filters and therein is presented with different advertising content although in other embodiments of the invention, such as depicted in FIG. 4, the advertising content may be the same. Subsequently, the user selects the feature, e.g. filter, and the message is transmitted to the other user. In the event that the user selects the “Rogers” filter depicted in second image 620 the recipient is presented with an image such as depicted in third image 630 where the advertiser Rogers™ is presented for a predetermined period of time before the advertisement disappears and the user is presented with the message in fourth image 640. Alternatively, if the user has selected the filter “AT&T” depicted in fifth image 650 then the the recipient is presented with an image such as depicted in third image 630 where the advertiser AT&T™ is presented within a portion of the display and the user presented immediately with the sender's message.

In each instance, if the recipient “selects” the displayed advertising content then they “click-through” to a location established by the advertiser, e.g. an advertisement upon a web page or channel such as YouTube™, for example. It would be evident that the “advertisement” may be static, dynamic, actionable (i.e. selectable to trigger a HTML link for example), non-actionable etc. It would be evident that the embodiments of the invention support all the known methodologies of establishing/selecting/providing advertisements and advertising content but now through an action of the user within another application such that the options/features of aspects of the application are now associable with advertising triggers/actions/events etc.

It would be evident that whilst embodiments of the invention presented supra in respect of FIGS. 4 to 6 are presented with respect to the selection of an image filter from a series of image filters within an application that the feature(s) of the software application may be any determined by the software application developer. Other examples, may include, but are not limited to:
selecting video versus photograph content to acquire/transmit;
selecting weapons/equipment/personnel within a gaming application;
selecting to add an attachment to a message within a messaging/email application; and
selecting a font to add text with.

Within other embodiments of the invention the advertiser or advertising content may be triggered by analysis of the image/content acquired by the user. For example, a photograph containing a vehicle may trigger recognition of the type, manufacturer, model, etc. of the vehicle and result in advertisements based upon the manufacturer, e.g. if it is a Ford™ it triggers an advertisement for their F-150 truck when the vehicle is a truck, based upon it being a truck such that Ford™, RAM™ and Toyota™ are associated with different filters for example. Alternatively, identifying a user is holding a drink triggers advertisers such as Pepsi™, Coke™, and Tropicana™. An image within a bar triggers different alcohol advertisements. An image of a street may trigger advertisements for local enterprises.

Alternatively, the advertiser or advertising content may be triggered by analysis of the image/content acquired by the user with respect to an individual or individuals within the image. For example, an image of a woman in a park taken by a man may trigger local advertisements for restaurants whereas a man against a car may trigger local advertisements for bars.

Within embodiments of the invention the advertisement or advertiser presented to the user exploiting the feature, e.g. an image filter, may be different to that presented to the recipient in contrast to the embodiment depicted in FIG. 6. For example, a user in Buffalo in upper New York state in the United States may be presented with AT&T™ as an advertiser but the recipient is located in Toronto, Ontario, Canada where there is no AT&T™ service provider. Accordingly, the ASPAP may replace AT&T™ with Rogers™ a wireless carrier in Toronto who is affiliated with AT&T™.

Optionally, an advertisement presented to the user may be presented as an overlay to the entire content sent by the user or as an overlay to a predetermined region of the content. Optionally, the advertisement may replace a predetermined region of the content. Optionally, the advertisement may be displayed to the recipient once, a predetermined number of times they view the content, or permanently.

Advertisers, third parties providing advertisements, etc. may be typically charged based upon the number of “click-throughs” although other basis may be established. In instances where the electronic address of the user and/or recipient are known the advertisement may also be sent to or alternatively sent to their electronic addresses. Optionally, a “click-through” may be associated with a call to action, e.g. save 10% today, such that a voucher or message to this effect is subsequently available. Optionally, such a call to action may, once the sending of the electronic content by the user is complete, launch a second application such as a map with directions to the nearest store, retailer, etc. compatible with the selected call to action.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
establishing within a software application in execution upon a device comprising a microprocessor the selection of a feature relating to first electronic content at least one of acquired and generated by a user of the device;
presenting to the user at least an option of a plurality of options with respect to the electronic content, each option associated with the feature; and
presenting to the user at least one of prior to and concurrently with the option of the plurality of options an first advertisement of a plurality of first advertisements, each first advertisement established in dependence upon at least the option of the plurality of options.

2. The method according to claim 1, further comprising
receiving an indication of selection of an option from the user;
transmitting second electronic content to at least one of a social network and another user;
transmitting data relating to the first advertisement of the plurality of first advertisements associated with the selection option;
presenting to the user the second electronic content and a second advertisement, the second advertisement established in dependence upon the data relating to the first advertisement of the plurality of first advertisements associated with the selection option.

3. The method according to claim 2, wherein
presenting to the user the second electronic content and a second advertisement comprises one of:
presenting the second advertisement for a predetermined period of time prior to presenting the second electronic content; or
presenting the second advertisement and second electronic content concurrently wherein the second advertisement at least one of overlays and replaces a predetermined portion of the second electronic content.

4. The method according to claim 1, wherein
the electronic content is at least one of a photograph, an image, audiovisual content, and multimedia content;
the feature is the application of an effect to the electronic content; and
the plurality of options are different effects.

5. The method according to claim 1, wherein
each first advertisement of a plurality of first advertisements is contextually relevant to the user and is established in dependence upon a set of factors, the factors selected from the group comprising biometrics of the user, geolocation data of the user, the electronic content, and the option of the plurality of options.

6. The method according to claim 1, wherein
the rate charged to an advertiser is based at least in dependence upon the popularity of the option of the plurality of options.

7. Executable instructions for execution upon a processor, the executable instructions for providing a process, the process comprising the steps of:
establishing within a software application in execution upon a device comprising a microprocessor the selection of a feature relating to first electronic content at least one of acquired and generated by a user of the device;
presenting to the user at least an option of a plurality of options with respect to the electronic content, each option associated with the feature; and
presenting to the user at least one of prior to and concurrently with the option of the plurality of options an first advertisement of a plurality of first advertisements, each first advertisement established in dependence upon at least the option of the plurality of options.

8. The executable instructions according to claim 7, further comprising
additional executable instructions for providing the further steps of:
receiving an indication of selection of an option from the user;
transmitting second electronic content to at least one of a social network and another user;
transmitting data relating to the first advertisement of the plurality of first advertisements associated with the selection option;
presenting to the user the second electronic content and a second advertisement, the second advertisement established in dependence upon the data relating to the first advertisement of the plurality of first advertisements associated with the selection option.

9. The executable instructions according to claim 8, wherein
presenting to the user the second electronic content and a second advertisement comprises one of:
presenting the second advertisement for a predetermined period of time prior to presenting the second electronic content; or
presenting the second advertisement and second electronic content concurrently wherein the second advertisement at least one of overlays and replaces a predetermined portion of the second electronic content.

10. The executable instructions according to claim 7, wherein
the electronic content is at least one of a photograph, an image, audiovisual content, and multimedia content;
the feature is the application of an effect to the electronic content; and
the plurality of options are different effects.

11. The executable instructions according to claim 7, wherein
each first advertisement of a plurality of first advertisements is contextually relevant to the user and is established in dependence upon a set of factors, the factors selected from the group comprising biometrics of the user, geolocation data of the user, the electronic content, and the option of the plurality of options.

12. The executable instructions according to claim 7, wherein
the rate charged to an advertiser is based at least in dependence upon the popularity of the option of the plurality of options.

13. A method comprising:
establishing within a software application in execution upon a device comprising a microprocessor first electronic content at least one of acquired and generated by a user of the device;
presenting to the user at least an option of a plurality of options with respect to the electronic content, each option associated with the feature;
analyzing the electronic content to identify at least a first element; and
presenting to the user at least one of prior to and concurrently with the option of the plurality of options a first advertisement of a plurality of first advertisements, each first advertisement established in dependence upon at least the option of the plurality of options and the first element.

14. The method according to claim 13, wherein
analyzing the electronic content to identify at least a first element comprises identifying a plurality of first elements; and
each first advertisement established in dependence upon at least the option of the plurality of options and a first element of the plurality of first elements.

15. The method according to claim 13, further comprising
receiving an indication of selection of an option from the user;
transmitting second electronic content to at least one of a social network and another user;
transmitting data relating to the first advertisement of the plurality of first advertisements associated with the selection option;
presenting to the user the second electronic content and a second advertisement, the second advertisement established in dependence upon the data relating to the first advertisement of the plurality of first advertisements associated with the selection option.

16. The method according to claim 13, wherein
presenting to the user the second electronic content and a second advertisement comprises one of:
presenting the second advertisement for a predetermined period of time prior to presenting the second electronic content; or
presenting the second advertisement and second electronic content concurrently wherein the second advertisement at least one of overlays and replaces a predetermined portion of the second electronic content.

17. The method according to claim 13, wherein
the electronic content is at least one of a photograph, an image, audiovisual content, and multimedia content.

18. The method according to claim 13, wherein
each first advertisement of a plurality of first advertisements is contextually relevant to the user and is established in dependence upon the first element and a factor, the factor selected from the group comprising biometrics of the user, geolocation data of the user, the electronic content, and the option of the plurality of options.

19. The method according to claim 13, wherein
the rate charged to an advertiser is based at least in dependence upon the popularity of the option of the plurality of options.
